(19) United States
(12) Patent Application Publication
(10) Pub. No.: US 2020/0153106 A1
(43) Pub. Date: May 14, 2020

(54) POLARIZATION CONVERSION INTEGRATED HORN ANTENNA AND METHOD OF MANUFACTURING THE SAME

(71) Applicant: Electronics and Telecommunications Research Institute, Daejeon (KR)

(72) Inventors: So-hyeun YUN, Daejeon (KR); Changsoo KWAK, Daejeon (KR); Man Seok UHM, Daejeon (KR); Hongyeol LEE, Sejong-si (KR); Dong Pil CHANG, Daejeon (KR)

(73) Assignee: Electronics and Telecommunications Research Institute, Daejeon (KR)

(21) Appl. No.: 16/542,422

(22) Filed: Aug. 16, 2019

(30) Foreign Application Priority Data
Nov. 9, 2018 (KR) 10-2018-0137416

(51) Int. Cl. H01Q 15/24; H01Q 13/02

(52) U.S. Cl. CPC H01Q 15/244; H01Q 13/02; H01Q 13/0283

(57) ABSTRACT

An integrated horn antenna with an integral polarization converter, and a method of manufacturing the integrated horn antenna are disclosed. The integrated horn antenna includes a horn, and a polarizer of which at least a portion is disposed in an internal space defined by an inner wall of the horn.

### CROSS-REFERENCE TO RELATED APPLICATIONS

This application claims the benefit under 35 USC § 119(a) of Korean Patent Application No. 10-2018-0137416 filed on Nov. 9, 2018, in the Korean Intellectual Property Office, the entire disclosure of which is incorporated herein by reference for all purposes.

### BACKGROUND

### 1. Field

The following description relates to an integrated horn antenna with an integral polarization converter and a method of manufacturing the integrated horn antenna.

### 2. Description of Related Art

A horn antenna is one type of aperture antennas that has a cross section of a waveguide increasing gradually towards the end thereof, and has a structure allowing electromagnetic wave energy to be radiatively transited between the waveguide and a space.

Recently, there has been an increasing use of multiple horns to implement multiple beams or shaped beams. In addition, there has been an increasing demand for a mobile antenna. Thus, research is ongoing to reduce a weight and a volume of a horn antenna to be used in this technical application field described above.

In general, a horn antenna includes a horn and a polarizer that are separately provided. In such a general case where a horn antenna includes a horn, a polarizer, and a transition being provided separately, it may not be easy to reduce a weight and a volume of the horn antenna by more than a certain point.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect provides technology for reducing a size and a weight of a horn antenna by disposing a polarizer inside a horn and providing an integrated horn antenna with an integral horn and polarizer.

According to an aspect, there is provided an integrated horn antenna including a horn, and a polarizer of which at least a portion is disposed in an internal space defined by an inner wall of the horn.

The polarizer may include a first portion disposed in a first internal space of the internal space that is defined by an inner wall of an aperture of the horn, and a second portion extended from the first portion in an opposite direction of the aperture of the horn, and disposed in a second internal space of the internal space that is defined by an inner wall of a waveguide of the horn.

The second portion may be disposed to correspond to at least a portion of the inner wall of the waveguide.

At least a portion of a surface in a circumferential direction of the second portion may be n contact with the inner wall of the waveguide.

The waveguide may include a fixing portion extended from the inner wall of the waveguide in a vertical direction to fix a portion of a lower part of the second portion.

The polarizer may further include a third portion extended from the second portion in an opposite direction of the aperture.

The integrated horn antenna may further include a transition connected directly to the waveguide. The third portion may be disposed to correspond to at least a portion of an inner wall of the transition.

At least a portion of a surface in a circumferential direction of the third portion may be in contact with the inner wall of the transition.

According to another aspect, there is provided a method of manufacturing an integrated horn antenna, the method including forming a horn, and disposing at least a portion of a polarizer in an internal space defined by an inner wall of the horn.

The disposing may include disposing a first portion of the polarizer in a first internal space of the internal space that is defined by an inner wall of an aperture of the horn, and disposing a second portion of the polarizer extended from the first portion in an opposite direction of the aperture of the horn in a second internal space of the internal space that is defined by an inner wall of a waveguide of the horn.

The second portion may be disposed to correspond to at least a portion of the inner wall of the waveguide.

At least a portion of a surface in a circumferential direction of the second portion may be in contact with the inner wall of the waveguide.

The forming of the horn may include forming the aperture, forming the waveguide, and forming a fixing portion extended from the inner wall of the waveguide in a vertical is direction to fix a portion of a lower part of the second portion.

The method may further include forming a transition connected directly to the waveguide.

A third portion of the polarizer extended from the second portion in an opposite direction of the aperture may be disposed to correspond to at least a portion of an inner wall of the transition.

At least a portion of a surface in a circumferential direction of the third portion may be in contact with the inner wall of the transition.

Other features and aspects will be apparent from the following detailed description, the drawings, and the claims.

### BRIEF DESCRIPTION OF THE DRAWINGS

FIG. 1 illustrates an example of a horn antenna in which a horn and a polarizer are simply combined.

FIG. 2 illustrates another example of a horn antenna in which a horn and a polarizer are simply combined.

FIG. 3 illustrates still another example of a horn antenna in which a horn and a polarizer are simply combined.

FIG. 4 illustrates yet another example of a horn antenna in which a horn and a polarizer are simply combined.

FIGS. 5A and 5B illustrate an example of an integrated horn antenna according to an example embodiment.

FIG. 6 is a transparent perspective view of a side face of the integrated horn antenna illustrated in FIG. 5.

FIG. 7 is a flowchart illustrating an example of a method of manufacturing an integrated horn antenna according to an example embodiment.

FIG. 8 illustrates an example of an electric field characteristic of an integrated horn is antenna without a polarizer.

FIG. 9 illustrates an example of an electric field characteristic of an integrated horn antenna.

FIG. 10 illustrates an example of a reflection loss characteristic of an integrated horn antenna.

FIG. 11 illustrates an example of a total efficiency characteristics over frequency of an integrated horn antenna.

FIG. 12 illustrates an example of a pattern characteristic of an integrated horn antenna.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be to apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein, Rather, the examples described herein have been provided merely to illustrate some of the many possible ways of implementing the methods, apparatuses, and/or systems described herein that will be apparent after an understanding of the disclosure of this application.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood. that the terms “comprises,” “comprising,” “includes,” and/or “including,” when used herein, specify the presence of stated features, integers, operations, elements, and/or components, but do not preclude the presence or addition of one or more other features, integers, operations, elements, components, and/or groups thereof.

Terms such as first, second, A, B, (a), (b), and the like may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In to addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings,

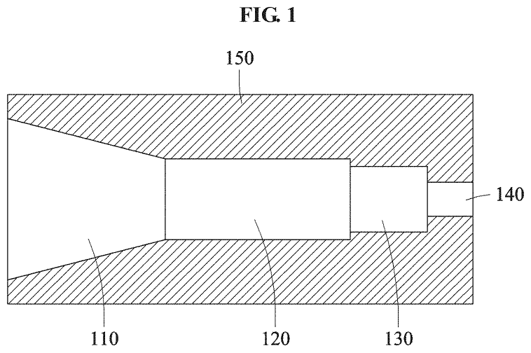

FIG. 1 illustrates an example of a horn antenna in which a horn and a polarizer are simply combined.

Referring to FIG. 1, a horn antenna, which is one type of aperture antenna, has a gradually widening cross section of a waveguide and has a structure through which electromagnetic energy is radiated and changed between the waveguide and a space.

The horn antenna includes a polarizer to convert a linearly polarized wave to a circularly polarized wave, or a circularly polarized wave to a linearly polarized wave. Herein, a polarized wave may be a path or trace formed by an end of an instantaneous field vector. The linearly polarized wave may be defined as a vertically polarized wave or a horizontally polarized wave based respectively on a vertical movement or a horizontal movement of a field vector over time. The circularly or elliptically polarized wave may be defined in accordance with ITU-R V.573, which is a recommendation of International Telecommunication Union (ITU) Radiocommunication Sector (ITU-R).

In terms of a direction in which an electric field travels, a rightward rotation or a clockwise rotation of an instantaneous field vector is referred to as a right hand circular polarized wave (RHCP), and a leftward rotation or a counterclockwise rotation of an instantaneous field vector is referred to as a left hand circular polarized wave (MCP). The circularly polarized wave may be generated when a signal magnitude of a vertically polarized wave and a signal magnitude of a horizontally polarized wave are identical to each other and a 90° phase difference occurs therebetween.

An axial ratio (AR) or a level of cross-polarization isolation (XPI) may be determined based on a magnitude ratio (r) between a vertically polarized wave and a horizontally polarized wave and a phase difference (Δϕ) therebetween. The axial ratio may be calculated as represented by Equation 1, and the XPI may be calculated as represented by Equation 2.

$$\begin{matrix}AR = sign ( sin Δφ ) \sqrt{\frac{1 + {r}^{2} + \sqrt{4 {r}^{2} {cos}^{2} Δφ + {( 1 - {r}^{2} )}^{2}}}{1 + {r}^{2} - \sqrt{4 {r}^{2} {cos}^{2} Δφ + {( 1 - {r}^{2} )}^{2}}}} \\ where , r = \vert {E}_{y} \vert / \vert {E}_{x} \vert \\ Δφ = ∠ {E}_{y} - {E}_{x} & [ Equation 1 ] \\ XPI = \frac{AR + 1}{AR - 1} & [ Equation 2 ]\end{matrix}$$

To transmit or receive a polarized wave-converted signal, an existing horn antenna may be provided in a form in which a horn and a polarizer are combined as illustrated in FIG. 1. In general, a horn antenna may include a horn and a polarizer that are separately provided. The existing horn antenna may be provided by separately developing the horn and the polarizer and assembling the horn and the polarizer as illustrated in FIGS. 1 through 4. In addition, a separate transition may be provided between the polarizer and a standard waveguide to excite a TE10-mode linearly polarized wave.

Referring to FIG. 1, the horn antenna includes a horn 110, a polarizer 120, a transition 130, and a standard waveguide 140, and an outer structure wall 150 for an interface and a flange. The polarizer 120 may also be referred to as a phase adjuster because it generates a circularly polarized wave by adjusting a phase while maintaining a same magnitude of a vertically polarized wave and a horizontally polarized wave.

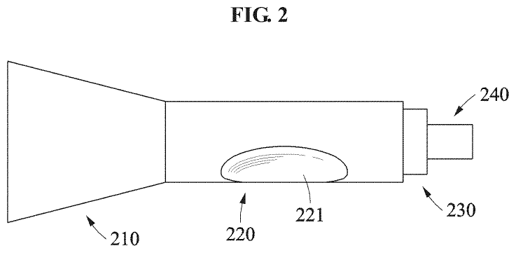

FIG. 2 illustrates another example of a horn antenna in which a horn and a polarizer are simply combined.

Referring to FIG. 2, a horn antenna includes an aperture 210, a polarizer 220, a transition 230, and a standard waveguide 240. A polarizer structure 221 may be embodied by a structure that is continuous and flat along an inner side wall of a waveguide, or by a stepped structure with another structure extended from the inner side wall. A side wall polarizer structure may be used pairwise to adjust phases of vertically and horizontally polarized waves. An existing horn antenna may have a cross-polarization characteristic of 25 decibels (dB), an axial ratio of 0.9 dB, and a reflection loss of 25 dB or greater. Although an antenna efficiency is not numerically described, a horn with multiple slopes may be proposed to prevent an efficiency degradation. A length of a horn, for example, including the aperture 210 and the polarizer 220 of FIG. 2, may be 10λ, or greater.

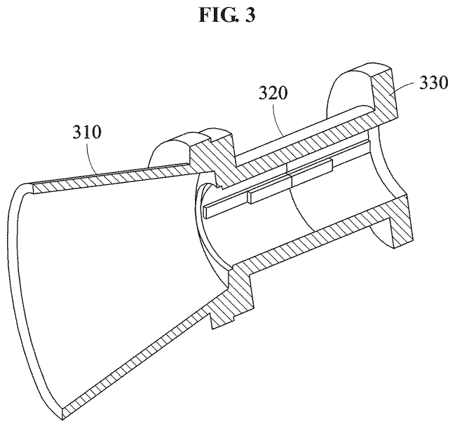

FIG. 3 illustrates still another example of a horn antenna in which a horn and a polarizer are simply combined.

Referring to FIG. 3, an elliptical reflector antenna or an elliptical feed horn may be used as a horn antenna to receive satellite broadcasts. When using multiple horns, it may be to advantageous because a physical space is obtained. Thus, as illustrated in FIG. 3, an elliptical transition 310, an additional phase difference generating structure 320, and a circular waveguide 330 may be included. The additional phase different generating structure 320 may be provided to generate a phase difference by the elliptical transition 310 and a phase difference of an opposite slope, and compensate for these. Although not illustrated in FIG. 3, a transition may also be needed to connect a standard waveguide. The elliptical feed horn may be more complex than a general circular feed horn and have a phase difference between a major axis electric field and a minor axis electric field. Thus, it may not be easy to achieve a cross-polarization characteristic.

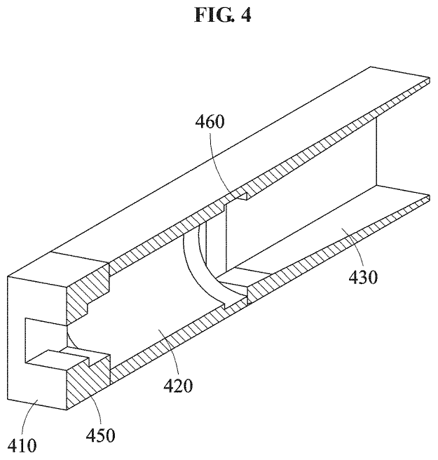

FIG. 4 illustrates yet another example of a horn antenna in which a horn and a polarizer are simply combined.

Referring to FIG. 4, a horn antenna may include a polarizer with an egg-shaped waveguide without using a dielectric slab or a metal post inside the waveguide. The egg-shaped waveguide may be formed with two circles with a same radius being connected to each other a predetermined distance therebetween and being rotated by 45 degrees relative to an input waveguide. An existing horn antenna may have a reflection loss of 28 dB in a 30 to 31 gigahertz (GHz) frequency band, a phase difference of approximately 90±5 degrees, and a magnitude difference of ±0.3 dB. This may indicate an axial ratio of approximately 1.1 dB based on Equation 1. As illustrated in FIG. 4, a horn antenna includes an input waveguide 410, a polarizer 420, an impedance matching 90-degree waveguide 460, and a horn 430. The existing horn antenna may use a transition 450 to connect the polarizer 420 and the input waveguide 410, for example, a WR28 standard waveguide. An entire length of the existing horn antenna may be 5.4λ, and efficiency may not be indicated.

As described above with reference to FIGS. 1 through 4, an existing horn antenna may include a horn and a circular polarization generator, separately, by varying a form of a polarizer, in order to improve performance and simplify a structure thereof. Recently, to to implement multiple beams or shaped beams, use of multiple horns is increasing. In addition, demand for a mobile antenna is also increasing. To use a horn antenna in such application fields, there has been research to reduce a weight and a volume of the horn antenna. However, when the horn antenna separately includes a horn, a polarizer, and a transition as illustrated in FIGS. 1 through 4, and it may not be easy to reduce the weight and volume of the horn antenna by a certain limit or greater.

In addition, when the horn antenna is used as an array element for the multiple beams of the shaped beams, a unit element may need to be highly efficient and be small in volume. Further, when the horn antenna is used in a multi-horn structure or a mobile type in, for example, a ship, a vehicle, an airplane, and a railroad, a volume and a weight of the horn antenna may need to be reduced to facilitate installation and/or operation.

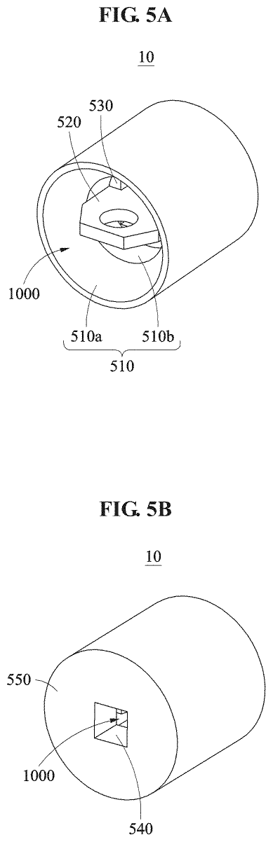

Hereinafter, an integrated horn antenna with an integral horn and polarizer according to example embodiments will be described in detail with reference to FIGS. 5 through 12.

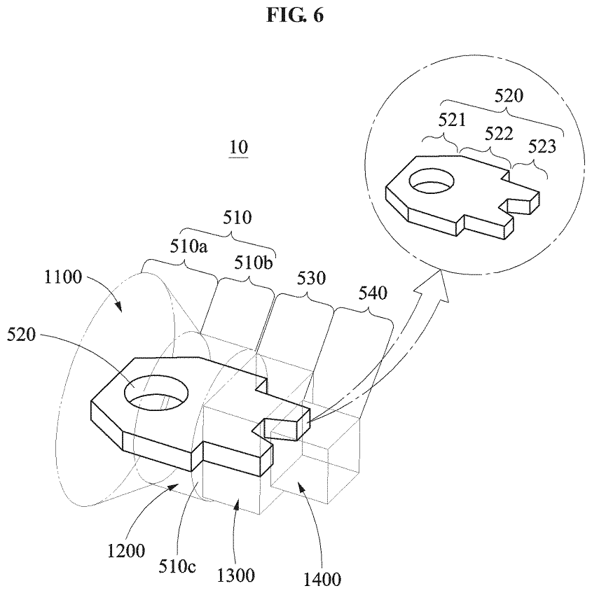

FIGS. 5A and 5B illustrate an example of an integrated horn antenna according to an example embodiment. FIG. 6 is a transparent perspective view illustrating a side face of the integrated horn antenna illustrated in FIG. 5.

Referring to FIGS. 5A and 5B, an integrated horn antenna 10 includes a horn 510 and a polarizer 520, The integrated horn antenna 10 further includes a transition 530, a standard waveguide 540, and an outer structure wall 550.

The integrated horn antenna 10 may be simplified in structure by integrating a function of a horn and a function of converting polarized waves into a single structure to transmit and receive a circularly polarized wave signal. An input and output of the integrated horn antenna 10 may be performed through the horn 510 and the standard waveguide 540.

The integrated horn antenna 10 may be embodied in a structure in which the polarizer 520 is inserted in the horn 510. In addition, the integrated horn antenna 10 may be to embodied in a structure in which the transition 530 is connected directly to the polarizer 520 and the transition 530 and the standard waveguide 540 are directly connected, and thus a length and a volume thereof may be considerably reduced.

Such an integral structure of the integrated horn antenna 10 may also reduce a volume of the outer structure wall 550, The integrated horn antenna 10 may be provided as an example, and an entire length of the integrated horn antenna 10 may only be 1.32λ.

The horn 510 includes an aperture 510a and a waveguide 510b. The horn 510 may guide electromagnetic waves to the aperture 510a to radiate the waves to an internal and/or external space.

At least a portion of the polarizer 520 may be disposed in an internal space 1000 defined by an inner wall of the horn 510. That is, the polarizer 520 may be inserted in the internal space 1000, The polarizer 520 may be inserted in the internal space 1000 and be closely combined with the inner wall that defines the internal space 1000, thereby being fixed to the internal space 1000.

In addition, the polarizer 520 may be disposed inside the horn 510 to integrate the horn 510 and the polarizer 520 into an integral form, and thus the integrated horn antenna 10 may become smaller in size and lighter in volume. Thus, an antenna system may be more simplified in its implementation and produced at a reduced cost.

The internal space 1000 includes a first internal space 1100 and a second internal space 1200. The internal space 1000 further includes a third internal space 1300 and a fourth internal space 1400.

The polarizer 520 may convert a linearly polarized wave to a circularly polarized wave. The polarizer 520 may also convert a circularly polarized wave to a linearly polarized wave.

For example, the polarizer 520 may be embodied in any forms, for example, an iris, a post, a dielectric, a septum, a groove, a corrugation, and a discontinuous cut section, that may to adjust a phase and convert polarized waves.

The transition 530 may be connected directly to the waveguide 510b. The transition 530 may be embodied in an integral form with the horn 510 and the polarizer 520.

The standard waveguide 540 may be connected directly to the transition 530. The standard waveguide 540 may be embodied in an integral form with the horn 510, the polarizer 520, and the transition 530.

The outer structure wall 550 may encompass the horn 510, the transition 530, and/or the standard waveguide 540, and surround an outer wall thereof. The outer structure 550 may be simplified in a cylindrical shape having a predetermined thickness. The outer structure wall 550 may be embodied in a form of solid figures, for example, a cylinder, a regular hexahedron, and a rectangular parallelepiped.

Referring to FIG. 6, the horn 510 includes the aperture 510a and the waveguide 510b. The polarizer 520 includes a first portion 521, a second portion 522, and a third portion 523.

The aperture 510a includes the first internal space 1100 defined by the inner wall, and the first portion 521 may be disposed in the first internal space 1100.

The waveguide 510b includes the second internal space 1200 defined by the inner wall, and the second portion 522 may be disposed in the second internal space 1200.

The waveguide 510b includes a fixing portion 510c extended from the inner wall of the waveguide 510b in a vertical direction to fix a portion of a lower part of the second portion 522. When the polarizer 520 is inserted in the second internal space 1200, the polarizer 520 may be fixed to the fixing portion 510c due to a form of the polarizer 520 corresponding to the fixing portion 510c.

The first portion 521 may be disposed in the first internal space 1100 of the internal space 1000 that is defined by the inner wall of the aperture 510a. of the horn 510.

The second portion 522 may be extended from the first portion 521 in an opposite direction of the aperture 510a of the horn 510. The opposite direction of the aperture 510a to indicates a direction in which a cross section of the aperture 510a is gradually narrowed.

The second portion 522 may be disposed in the second internal space 1200 of the internal space 1000 that is defined by the inner wall of the waveguide 510b of the horn 510, The second portion 522 may be disposed to correspond to at least a portion of the inner wall of the waveguide 510b. In addition, at least a portion of a surface in a circumferential direction of the second portion 522 may be in contact with the inner wall of the waveguide 510b.

The third portion 523 may be extended from the second portion 522 in an opposite direction of the aperture 510a, The third portion 523 may be disposed in the third internal space 1300 of the internal space 1000 that is defined by an inner wall of the transition 530 of the horn 510. The third portion 523 may be disposed to correspond to at least a portion of the inner wall of the transition 530, In addition, at least a portion of a surface in a circumferential direction of the third portion 523 may be in contact with the inner wall of the transition 530.

The third portion 523 may include a third fixing portion (not shown) to fasten the third portion 523 to the inner wall of the transition 530. The third fixing portion may be formed on one side of a contact surface on which the third portion 523 is in contact with the third internal space 1300.

The third internal space 1300 may include a fourth fixing portion (not shown) to fasten the third portion 523 to the contact surface. The fourth fixing portion may be formed on one side of a contact surface of the inner wall of the transition 530.

The third portion 523 may be detachably fastened to the third fixing portion and the fourth fixing portion to be fastened to the transition 530.

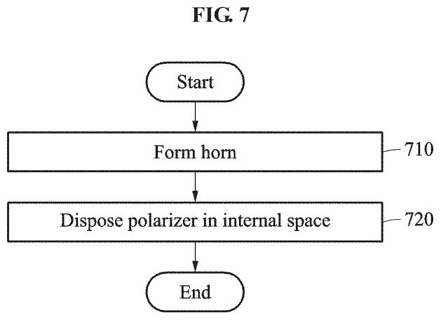

FIG. 7 is a flowchart illustrating an example of a method of manufacturing an integrated horn antenna according to an example embodiment.

Referring to FIG. 7, in operation 710, the horn 510 is formed. For example, as to illustrated, the horn 510 is formed with the aperture 510a and the waveguide 510b being included therein. The waveguide 510b may include the fixing portion 510c extended from the inner wall of the waveguide 510b in a vertical direction to fix a portion of a lower part of the second portion 522.

In operation 720, at least a portion of the polarizer 520 is disposed in an internal space defined by the inner wall of the horn 510. For example, as illustrated, the first portion 521 of the polarizer 520 may be disposed in the first internal space 1100 of the internal space 1000 that is defined by the inner wall of the aperture 510a of the horn 510.

In addition, the second portion 522 of the polarizer 520 that is extended from the first portion 521 in an opposite direction of the aperture 510a of the horn 510 may be disposed in the second internal space 1200 of the internal space 1000 that is defined by the inner wall of the waveguide 510b of the horn 510. Here, the second portion 522 may be disposed to correspond to at least a portion of the inner wall of the waveguide 510b.

Further, the transition 530 may be connected directly to the waveguide 510b. Here, the third portion 523 may be disposed to correspond to at least a portion of the inner wall of the transition 530.

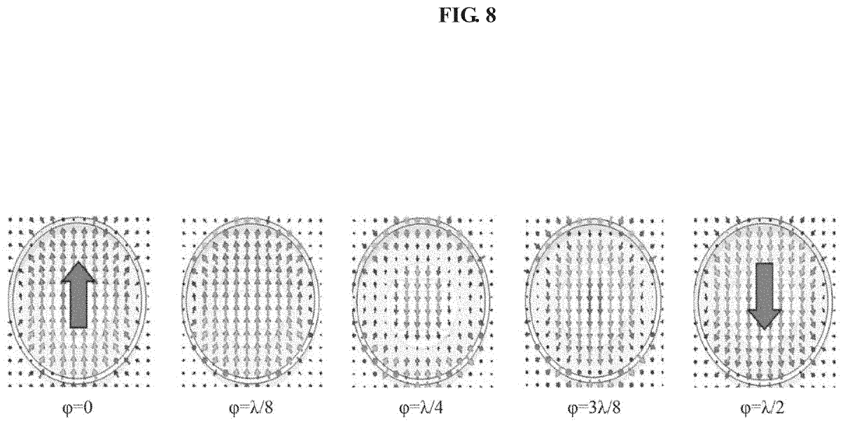

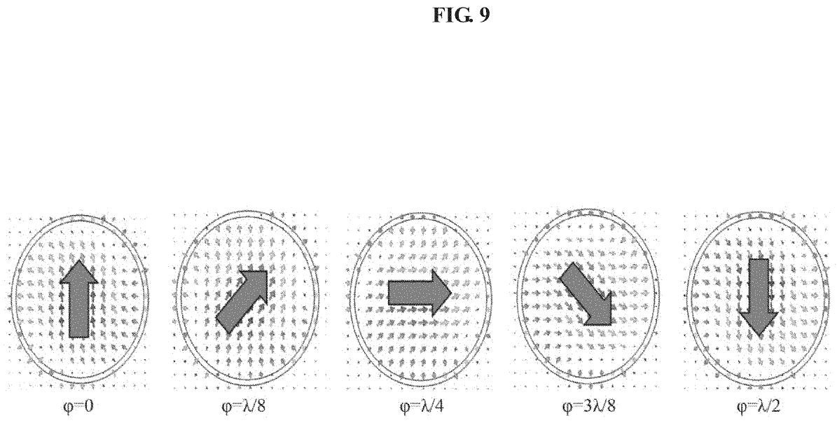

FIG. 8 illustrates an example of an electric field characteristic of an integrated horn antenna without a polarizer. FIG. 9 illustrates an example of an electric field characteristic of an integrated horn antenna including a polarizer.

Referring to FIG. 8, when the integrated horn antenna 10 does not include the polarizer 520, an electric field may not rotate over time, but proceed only in a straight direction.

Referring to FIG. 9, when the integrated horn antenna 10 includes therein the polarizer 520, an electric field may rotate to transmit and receive a circularly polarized wave. Here, a rotation direction in which the electric field rotates, for example, whether the electric field rotates rightwards or leftwards, may be determined based on a position of the polarizer to 520. For example, a rightward circular polarization characteristic is illustrated in FIG. 9.

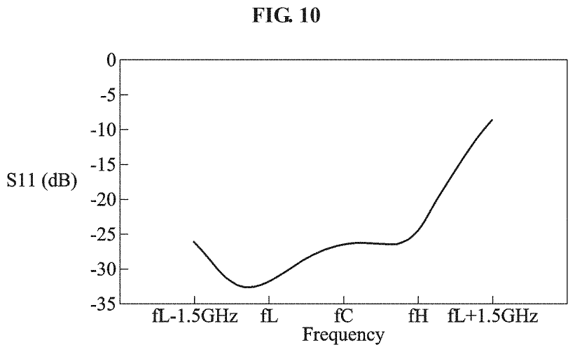

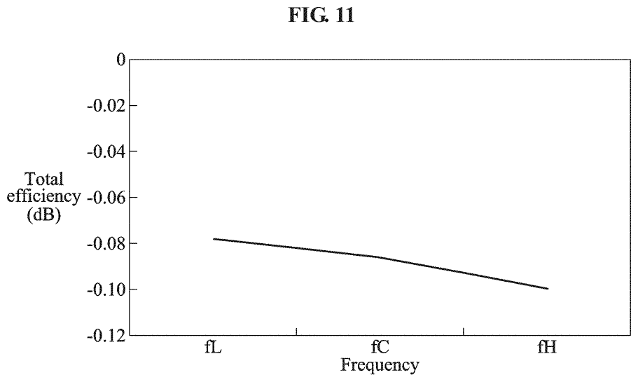

FIG. 10 illustrates an example of a reflection loss characteristic of an integrated horn antenna. FIG. 11 illustrates an example of a total efficiency characteristics over frequency of an integrated horn antenna.

Referring to FIG. 10, the integrated horn antenna 10 may have a reflection loss of 25 dB or greater in an operating frequency band.

Referring to FIG. 11, the integrated horn antenna 10 may have a total efficiency of approximately −1 dB or greater in an operating frequency band, which may indicate 97.7% of antenna efficiency.

An existing horn antenna may be embodied as having a length of 5 to 10λ or greater, whereas the integrated horn antenna 10 may be reduced in length by 76% to 90% from that of the existing horn antenna. Thus, with only a length of 1.3λ, the integrated horn antenna 10 may have a high efficiency. Compared to the existing horn antenna, the integrated horn antenna 10 may have a high efficiency only with a length that is 24% to 10% of the length of the existing horn antenna.

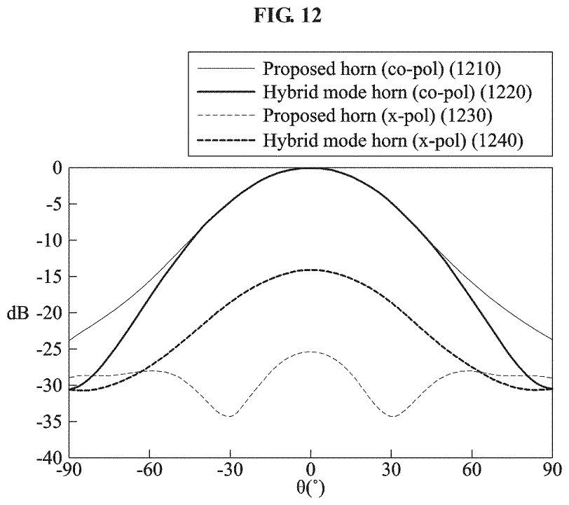

FIG. 12 illustrates an example of a pattern characteristic of an integrated horn antenna.

Referring to FIG. 12, a second line 1220 indicates a pattern of a theoretical hybrid mode horn in which TE11 mode and TM11 mode are combined. A first line 1210 and the second line 1220 indicate a co-polarized wave characteristic, and a third line 1230 and a fourth line 1240 indicate a cross-polarized wave characteristic. As illustrated, a cross-polarized wave characteristic of the theoretical hybrid mode horn is approximately 15 dB.

The first line 1210 indicates a co-polarized wave characteristic of the integrated horn antenna 10, and the third line 1230 indicates a cross-polarized wave characteristic of the integrated horn antenna 10. As illustrated, the cross-polarized wave characteristic of the integrated horn antenna 10 is approximately 25 dB, and may have an axial ratio of 0.92 dB based on Equation 2.

Thus, it is verified as illustrated in FIG. 12 that the integrated horn antenna 10 has an improved cross-polarized wave characteristic compared to the theoretical hybrid mode horn antenna.

As described above with reference to FIGS. 8 through 12, the integrated horn antenna 10 may be reduced in volume and weight while maintaining an electrical performance, and thus be effective used for a phased array antenna with multiple horns and an antenna installed in a mobile transport means, for example, a ship, a vehicle, and an airplane, and installed in a railroad.

While this disclosure includes specific examples, it will be apparent to one of ordinary skill in the art, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. An integrated horn antenna, comprising:
a horn: and
a polarizer of which at least a portion is disposed in an internal space defined by an inner wall of the horn.

2. The integrated horn antenna of claim 1, wherein the polarizer comprises:
a first portion disposed in a first internal space of the internal space that is defined by an inner wall of an aperture of the horn; and
a second portion extended from the first portion in an opposite direction of the aperture of the horn, and disposed in a second internal space of the internal space that is defined by an inner wall of a waveguide of the horn.

3. The integrated horn antenna of claim 2, wherein the second portion is disposed to correspond to at least a portion of the inner wall of the waveguide.

4. The integrated horn antenna of claim 3, wherein at least a portion of a surface in a circumferential direction of the second portion is in contact with the inner wall of the waveguide.

5. The integrated horn antenna of claim 4, wherein the waveguide comprises:
a fixing portion extended from the inner wall of the waveguide in a vertical direction to fix a portion of a lower part of the second portion.

6. The integrated horn antenna of claim 2, wherein the polarizer further comprises:
a third portion extended from the second portion in an opposite direction of the aperture.

7. The integrated horn antenna of claim 6, further comprising:
a transition connected directly to the waveguide,
wherein the third portion is disposed to correspond to at least a portion of an inner wall of the transition.

8. The integrated horn antenna of claim 7, wherein at least a portion of a surface in a circumferential direction of the third portion is in contact with the inner wall of the transition.

9. A method of manufacturing an integrated horn antenna, comprising:
forming a horn; and
disposing at least a portion of a polarizer in an internal space defined by an inner wall of the horn.

10. The method of claim 9, wherein the disposing comprises:
disposing a first portion of the polarizer in a first internal space of the internal space that is defined by an inner wall of an aperture of the horn; and
disposing a second portion of the polarizer extended from the first portion in an opposite direction of the aperture of the horn in a second internal space of the internal space that is defined by an inner wall of a waveguide of the horn.

11. The method of claim 10, wherein the second portion is disposed to correspond to at least a portion of the inner wall of the waveguide.

12. The method of claim 11, wherein at least a portion of a surface in a circumferential direction of the second portion is in contact with the inner wall of the waveguide.

13. The method of claim 12, wherein the forming of the horn comprises:
forming the aperture;
forming the waveguide; and
forming a fixing portion extended from the inner wall of the waveguide in a vertical direction to fix a portion of a lower part of the second portion.

14. The method of claim 10, further comprising:
forming a transition connected directly to the waveguide,
wherein a third portion of the polarizer extended from the second portion in an opposite direction of the aperture is disposed to correspond to at least a portion of an inner wall of the transition.

15. The method of claim 14, wherein at least a portion of a surface in a circumferential direction of the third portion is in contact with the inner wall of the transition.
